(19) United States
(12) Patent Application Publication
(10) Pub. No.: US 2006/0273920 A1
(43) Pub. Date: Dec. 7, 2006

(54) Method and system for automatic patron queuing using radio frequency identification embedded personal communication devices

(75) Inventors: Christopher Hoang Doan, Austin, TX (US); Mei Fat Hau, Berkshire (GB); Leonel Saenz III, Austin, TX (US); Thanh K. Tran, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/143,332

(22) Filed: Jun. 2, 2005

(51) Int. Cl. G08B 5/22

(52) U.S. Cl. 340/825.29; 705/5; 340/7.23

(57) ABSTRACT

A data processing system for automatically queuing a patron. A patron registers for a queue at a merchant's place of business by using a Personal Communication Device (PCD) and is placed in a queue. Subsequent to being placed in the queue, the patron waits for an event to occur. When the event occurs, the patron is notified by way of the PCD. The patron acknowledges notification via the PCD and is removed from the queue.

### BACKGROUND OF THE INVENTION

1. Technical Field

The present invention relates to an improved data processing system. More specifically, the present invention is directed to a method, apparatus, and computer program product for queuing a patron automatically.

2. Description of Related Art

Queuing means to form a line while waiting for something. Queuing is the process of lining up people or events in the order you want to process them. For example, telephone calls to a company's customer service number may be placed in a “hold queue” waiting to be answered in the order that the call was received. In computing, queuing is a series of tasks waiting to be processed automatically one after the other by a computer system.

Typical examples of patron queuing systems utilized by merchants today are: 1) placing patrons in long lines to wait for doors to open, such as at movie theaters; 2) having patrons “take a number” to wait for service, such as at a busy grocery meat counter; and 3) giving patrons remote pagers to wait for available seating, such as at a restaurant. A problem with the first approach is that time spent standing in a traditional line of people is physically and psychologically taxing to patrons and is not very enjoyable. Also, the business may find it desirable to allow patrons to effectively “wait” in line while engaging in other activities, such as, for example, purchasing concessions or going to the restroom prior to entering a theater.

A problem with the second approach is that the patron has to stay close enough to hear a vocal number announcement, especially in a noisy environment or if the patron is hearing impaired or stay in a position capable of seeing a displayed number announcement. Thus, the second approach effectively prevents the patron from moving away from the number source. A further disadvantage to current merchant patron queuing systems is that the second and third approaches require a patron to keep track of an additional item during the wait time, which is annoying and may be misplaced. Also, in the second and third approaches the merchant has to purchase, maintain, and replace the items given to patrons for queuing, thus increasing merchant overhead.

Therefore, it would be advantageous to have an improved method and apparatus to automatically queue patrons using the patron's own personal communication device.

### SUMMARY OF THE INVENTION

The present invention provides a method, apparatus, and computer program product for automatically queuing a patron. The process of the present invention begins with a patron registering for a queue at a merchant's place of business by using a Personal Communication Device (PCD). In a preferred embodiment of the present invention, the patron's PCD is embedded with a radio frequency identification (RFID) tag, which has a unique signature. The unique RFID tag signature is detected by an RFID reader at the merchant's place of business. After detecting the patron's unique PCD RFID signature, the RFID reader then transmits the unique signature to a merchant server. The merchant server places the patron's unique RFID signature in a queue subsequent to registration and waits for an event to occur. The patron is notified by the merchant server via the PCD that the event has occurred. After receiving the notification, the patron acknowledges notification via the PCD and is removed from the queue.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial illustration of a distributed data processing system in which the present invention may be implemented;

FIG. 2 is an exemplary block diagram of a data processing system that may be implemented as a server in accordance with a preferred embodiment of the present invention;

FIG. 3A is an exemplary pictorial representation of a personal communication device (PCD) in accordance with a preferred embodiment of the present invention;

FIG. 3B is an exemplary block diagram illustrating the hardware configuration of a PCD in accordance with a preferred embodiment of the present invention;

FIG. 4 is an exemplary flowchart illustrating a method for queuing patrons in accordance with a preferred embodiment of the present invention; and

FIG. 5 is a pictorial representation of a specific example of how patrons may be queued in accordance with a preferred embodiment of the present invention.

### DETAILED DESCRIPTION OF THE PREFERRED EMBODIMENT

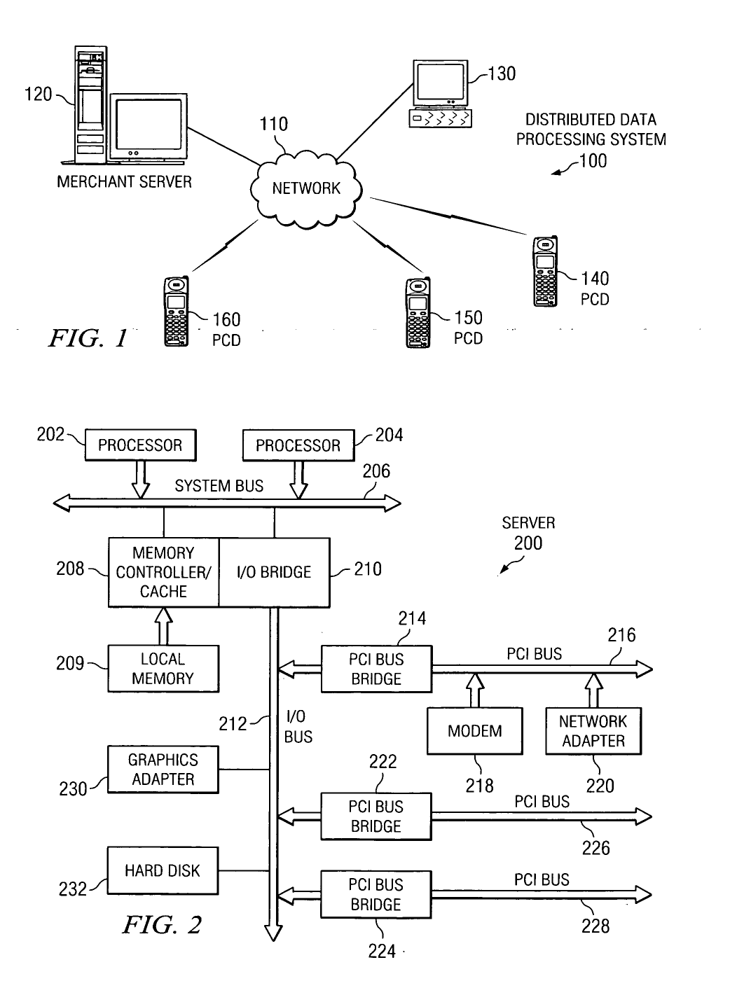

With reference now to the figures, FIG. 1 depicts a pictorial illustration of a distributed data processing system in which the present invention may be implemented. Distributed data processing system 100 is a network of computers in which the present invention may be implemented. Distributed data processing system 100 contains network 110, which is the medium used to provide communications links between various devices and computers connected together within distributed data processing system 100. Network 110 may include several types of connections, such as wire, wireless communication links, or fiber optic cables. However, for the purposes of the present invention, wireless communication links will be emphasized.

In the depicted example, server 120 is connected to network 110. Server 120 is a merchant server with high speed connections to network 110. In addition, clients 130, 140, 150, and 160 are connected to network 110. Client 130 is a personal computer using a conventional land line communication link. Clients 140, 150, and 160 are personal communication devices (PCDs) relying on wireless communication links. The PCDs may be, for example, a cellular telephone, a personal digital assistant, or a handheld computer or any combination thereof. In addition, the PCDs are not restricted to the above stated list of devices. The PCDs may be any device capable of wireless communication. Clients 140, 150, and 160 are clients to server 120. Distributed data processing system 100 may include additional servers, clients, and other devices not shown.

In the depicted example, distributed data processing system 100 is the Internet with network 110 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. FIG. 1 is intended as an example, and not as an architectural limitation for the present invention.

Referring now to FIG. 2, an exemplary block diagram of a data processing system that may be implemented as a server in accordance with a preferred embodiment of the present invention is shown. Server 200 may be for example merchant server 120 in FIG. 1. Server 200 employs a peripheral component interconnect (PCI) local bus architecture. Although the depicted example utilizes a PCI bus, other bus architectures such as Accelerated Graphics Port (AGP) and Industry Standard Architecture (ISA) may be used.

Server 200 may be a symmetric multiprocessor (SMP) system including a plurality of processors 202 and 204 connected to system bus 206. Alternatively, a single processor system may be employed. Also, connected to system bus 206 is memory controller/cache 208, which provides an interface to local memory 209. Input/Output (I/O) bus bridge 210 is connected to system bus 206 and provides an interface to I/O bus 212. Memory controller/cache 208 and I/O bus bridge 210 may be integrated as depicted.

PCI bus bridge 214 connected to I/O bus 212 provides an interface to PCI local bus 216. A number of modems may be connected to PCI bus 216. Typical PCI bus implementations will support four PCI expansion slots or add-in connectors. Communications links to clients, such as for example, clients 140-160 in FIG. 1, may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, Server 200 allows connections to multiple network computers and PCDs. A memory-mapped graphics adapter 230 and hard disk 232 may also be connected to I/O bus 212 as depicted, either directly or indirectly.

The present invention provides a method, apparatus, and computer program product for automatically queuing a patron at a merchant's place of business. A patron registers for a queue by using a Personal Communication Device (PCD) and is subsequently placed in a queue. After being placed in the queue, the patron waits for an event time to be reached or for a seat to become available. The patron is notified by way of the PCD when the event time has been reached or when the seat is available. The patron acknowledges the notification via the PCD and is removed from the queue.

The present invention provides crowd control and reserved priorities using the patron's PCD, such as, for example, a cellular telephone with an embedded radio frequency identification tag with a unique signature. Radio frequency identification, or RFID, is a generic term for technologies that use radio waves to automatically identify people or objects. There are several methods of identification, but the most common is to store a serial number that identifies a person or object, and perhaps other information, on a microchip that is attached to an antenna. The microchip and the antenna together are called an RFID transponder or an RFID tag. The antenna enables the chip to transmit the identification information to a reader or interrogator. The reader converts the radio waves reflected back from the RFID tag into digital information that can then be conveyed to computers that can utilize the information.

An advantage of the present invention is that the patron will not be required to carry an extra device, such as a pager, given to the patron by a merchant for the purpose of notification when the patron is at the top of the queue. The current invention will leverage technology already owned by the patron. In addition, the merchant will not be required to purchase and provide the extra device to the patron, thus decreasing the merchant's overhead.

Another advantage of the present invention will be that the queuing process will not have to be performed manually by a merchant employee one at a time. Consequently, the merchant's manpower requirements will be reduced. The present invention provides an automatic system for placing patrons in and removing patrons from a queue. However, there still may be human intervention in the process of the present invention for the selection and control of who, when, and how many patrons enter the merchant's place of business.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pseries system, a product of International Business Machines Corporation in Armonk, N.Y., running the Advanced Interactive Executive (AIX) or Linux operating systems.

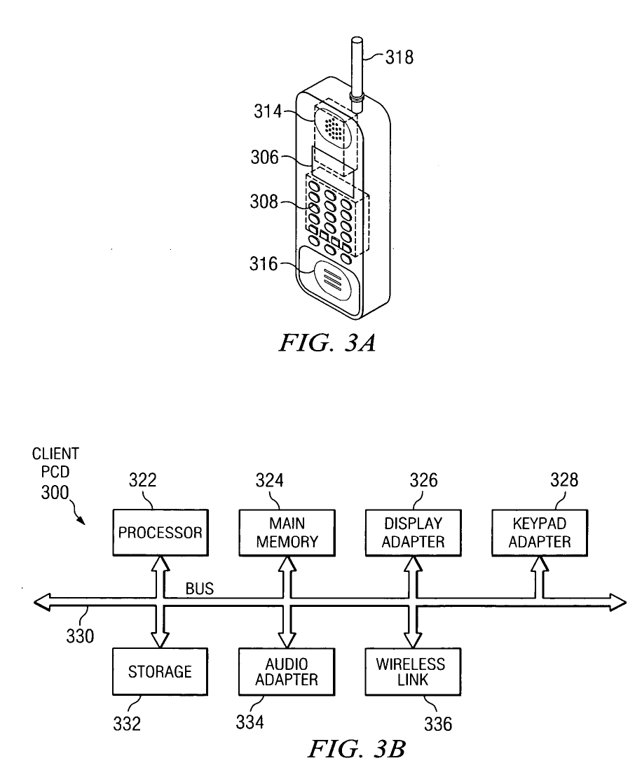

With reference now to FIG. 3A, an exemplary pictorial representation of a personal communication device (PCD) is depicted in accordance with a preferred embodiment of the present invention. In this illustrative example, client PCD 300 is a mobile cellular telephone, although any PCD may be used. Client PCD 300 may be, for example, client PCDs 140-160 in FIG. 1. Client PCD 300 may include display 306 for presenting textual and graphical information. Display 306 may be a known display device, such as a liquid crystal display (LCD).

Client PCD 300 may also include keypad 308, speaker 314, and microphone 316. Keypad 308 may be used to enter, for example, user identification information, commands for interacting with the interface, and telephone numbers. Audio feedback may be presented via speaker 314. Microphone 316 may be used not only for voice conversation, but for entering specific voice commands for voice actuated functions. Client PCD 300 also includes antenna 318, which is necessary for establishing wireless communication links with a network, such as for example, network 110 in FIG. 1.

Now turning to FIG. 3B, an exemplary block diagram illustrating the hardware configuration of a PCD in accordance with a preferred embodiment of the present invention is depicted. FIG. 3B illustrates the increasing sophistication of modern PCD designs.

Client PCD 300 utilizes bus architecture. Processor 322 and main memory 324 are connected to bus 330. Display adapter 326, keypad adapter 328, storage 332, and audio adapter 334 are also connected to bus 330. In addition, Client PCD 300 includes wireless link 336 connected to bus 330. Wireless link 336 may be, for example, radio frequency identification (RFID), microwave, shortwave, wireless fidelity (Wi-Fi), Bluetooth, and the like. Those of ordinary skill in the art will appreciate that the hardware in FIG. 3B may vary depending on the implementation. Other internal hardware or peripheral devices may be used in addition to or in place of the hardware depicted in FIG. 3B.

Client PCD 300 may rely on Wireless Application Protocol (WAP) for facilitating communications. WAP is a standard for providing wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML), which was derived from Phone.com's Handheld Device Markup Language (HDML) and is a streamlined version of HTML for small screen displays. Also, WAP uses WMLScript, a compact JavaScript-like language that runs in limited memory. In addition, WAP supports handheld input methods such as keypad and voice recognition.

WAP runs over all the major wireless networks in place. Also, WAP is device independent, requiring only a minimum functionality in the unit so that it can be used with a myriad of cellular phones and handheld devices. However, it should be pointed out that WAP has been described for illustrative purposes, and other wireless protocols may be used to implement the present invention.

The depicted example in FIG. 3B and examples described above are not meant to imply architectural limitations. In addition, the use of wireless communications protocols for Internet access need not be restricted to PCDs. The present invention may be applied to other wireless devices which have similar communications protocols. PCDs are used merely for illustrative purposes.

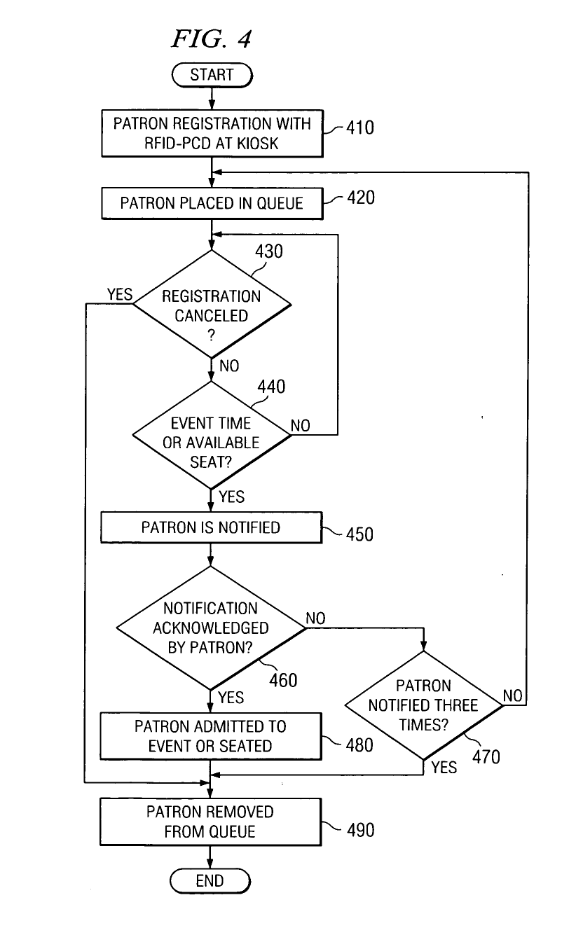

Turning now to FIG. 4, an exemplary flowchart is shown illustrating a method for queuing patrons in accordance with a preferred embodiment of the present invention. The process begins when a patron registers to be placed in a queue or waiting list at a merchant's place of business by using a PCD embedded with an RFID tag (step 410). The PCD may be, for example, client PCD 300 in FIG. 3A.

The patron registers for the queue in order to be admitted to an event, such as, for example, a movie at a theater or seated at a restaurant table. However, the present invention is not restricted to queuing patrons for theaters and movies. The present invention may be employed in a multitude of settings where patrons are made to wait for an event to occur. The event may be, for example, a specified time, an available seat, or both.

Patron registration for a queue may be performed either actively or passively. With regard to active registration, a patron may, for example, register at a kiosk in a merchant's waiting area or lobby. Each RFID tag or microchip transmits a signal with a unique identification signature or serial number. The unique signature of the patron's PCD embedded with the RFID tag may be used to identify the patron for the queue. The embedded RFID tag or microchip in the PCD may also contain other information, such as, a telephone number or access code for the PCD. Transmitting the telephone number or access code of the PCD by the RFID tag, may allow text messages or displays to be received by the PCD.

The merchant's patron registration kiosk may contain, for example, an RFID reader in order to detect signals from RFID tags and a personal or notebook computer, such as, for example, client computer 130 in FIG. 1 for the purpose of completing the active registration process. When a patron with a PCD, embedded with an RFID tag, comes into close proximity, for example, two feet, of the kiosk containing the RFID reader, the patron's RFID embedded PCD unique signature is detected by the RFID reader. Subsequent to the RFID reader detecting the PCD's unique signature transmitted by the embedded RFID tag, a message may, for example, be displayed on the screen of the kiosk computer asking if the patron wishes to register the unique RFID signature for the queue. The patron then take an affirmative action in the registration process by entering an appropriate keyboard, voice, or touch screen command at the kiosk computer to indicate the patron's intentions.

Alternatively, a text message or display may be sent to the patron's PCD, using the RFID tag transmitted telephone number or access code for the PCD, asking if the patron desires to place the PCD's unique RFID signature in the queue. Again, the patron may affirmatively respond via the PCD to place the unique RFID signature in the queue. Further, if a patron does not own a PCD with an embedded RFID tag, then a merchant employee may register the patron without an RFID embedded PCD for the queue by using the kiosk personal or notebook computer.

With regard to passive registration, the patron may passively register to be placed in a queue by passing an RFID reader/interrogator located, for example, near the entrance to a merchant's place of business with an RFID enabled PCD. The RFID reader automatically detects and transmits the RFID number signal unique to that patron's PCD and the PCD's telephone number or access code. A merchant server, such as, for example, merchant server 120 in FIG. 1, receives the patron's PCD unique RFID signature and telephone number or access code from the RFID reader.

The merchant server places the patron's PCD unique RFID signature in a queue or waiting list (step 420). The merchant server may confirm the patron's placement and position in the queue by sending a confirmation notice to the patron's PCD display, such as, for example, display 306, on client PCD 300, in FIG. 3A. In addition to the confirmation notice, the merchant server may send other information to the patron's display as well. The other information provided by the merchant server may include, but is not restricted to, estimated patron wait time and updated queue status. Status updates may be sent to the patron's PCD display, for example, every ten minutes.

Several types of patron registration may be utilized by the merchant server. One type of registration may be First In/First Out (FIFO). In other words, the first patron placed in the queue is the first patron taken out of the queue. FIFO may be employed, for example, in a restaurant situation where patrons are seated, as seating becomes available, on a first come/first served basis. Another type of registration may be to place patrons in queue groups according to specified event times. Queue groups may occur in cases such as movie start times, where several patrons will enter the theater together. Yet another type of registration may be priority registration. Priority registration may be performed for known VIPs of the merchant. The merchant server may identify a VIP by the previously recorded unique PCD RFID signature. For example, the merchant server may record the number of times a unique PCD RFID signature is placed in a queue over a predetermined period of time. Patrons having been placed in a queue, for example, twelve times in a six-month period, may have their unique PCD RFID signature placed on a VIP list by the merchant server. Subsequently, when a patron that has been placed on the merchant's VIP list registers at the kiosk, the merchant server places the VIP's PCD RFID number at a higher priority in the queue.

After the patron is placed in the queue in step 420, a determination is made as to whether the patron's registration is canceled (step 430). If the patron's registration is canceled (yes output of step 430), then the patron's unique PCD RFID signature is removed from the queue (step 490) and the process terminates thereafter.

Cancellation of the patron's registration may be performed by the patron or by the merchant server. With regard to patron cancellation, the patron may, for example, decide that the wait time is too long and cancel the registration via the PCD by sending a message to the merchant server to remove the patron's unique RFID signature from the queue. Alternatively, the patron may cancel queue registration in a similar manner as when the patron initially registered using the kiosk.

With regard to merchant server cancellation of a patron queue registration, the merchant server may, for example, cancel the patron registration when the server determines that the queue is full or closed. More specifically, the merchant server will cancel a patron registration when, for example, a movie theater has only 250 seats available for a specific movie start time and the merchant server already has 250 patrons listed in the queue. Cancellation of subsequent patron registration, after the queue is determined to be full, may be sent by the merchant server to the patron's PCD display.

If the patron registration is not canceled (no output of step 430), then a determination is made as to whether the specified start time for the event has been reached or seating is now available for the patron (step 440). If the event time has not been reached or seating is still not available (no output of step 440), then the process returns to step 430. If the event time has been reached or seating is now available for the patron (yes output of step 440), then the patron is notified by the merchant server on his or her RFID embedded PCD (step 450). Patron notification may be sent by the merchant server via displayed text message, recorded voice message, vibrations, or ring tones on the patron's PCD. It should be noted that the merchant server may notify patrons individually or in groups. For example, the merchant server may notify patrons one at a time, such as for individual seating at a restaurant as seating becomes available, or may notify several patrons at the same time, such as for mass seating in a movie theater for a particular movie start time for which the patrons are registered. Additionally, the merchant server may utilize a combination of notification techniques, such as, for example, both individually and in groups at the same time and is not limited to the above stated examples.

After the patron has been notified in step 450, then a determination is made as to whether the patron acknowledged the notification message sent by the merchant server (step 460). The acknowledgement period for patron response to the merchant server's notification of available seating or event start may be, for example, 2 minutes. Patron notification acknowledgement may be accomplished by various methods. Active acknowledgement of patron notification may be accomplished by using, for example, a keyboard, voice, or touch screen command on the kiosk computer. Another active acknowledgment method may be via the patron's RFID embedded PCD.

Passive acknowledgement of patron notification may be accomplished by passing, for example, an RFID reader located near the entrance to the event. The process of passive acknowledgement is similar to passive registration as discussed above. If the patron has acknowledged the notification (yes output of step 460), then the patron is admitted to the event or seated (step 480). Subsequent to the patron being seated or admitted to the event in step 480, the patron's unique PCD RFID signature is removed from the queue (step 490) and the process terminates thereafter.

If the patron has not acknowledged notification sent by the merchant server to the patron's PCD within an acknowledgement period (e.g., 2 minutes) (no output of step 460), then the merchant server will determine whether the patron has been notified a predetermined number of times (e.g., three times) that the event time has been reached or that seating is now available (step 470). If the patron has not been notified three times by the merchant server (no output of step 470), then the process returns to step 420 where the patron remains in the queue or is placed in the next queue group. If the patron has been notified by the merchant server three times (yes output of step 470), then the merchant server removes the patron's unique PCD RFID signature from the queue (step 490). A lack of patron acknowledgement after three notifications may occur, for example, if the patron leaves the merchant's place of business or if the patron does not know how to acknowledge notification and is still admitted to the event by merchant employees. The process terminates thereafter.

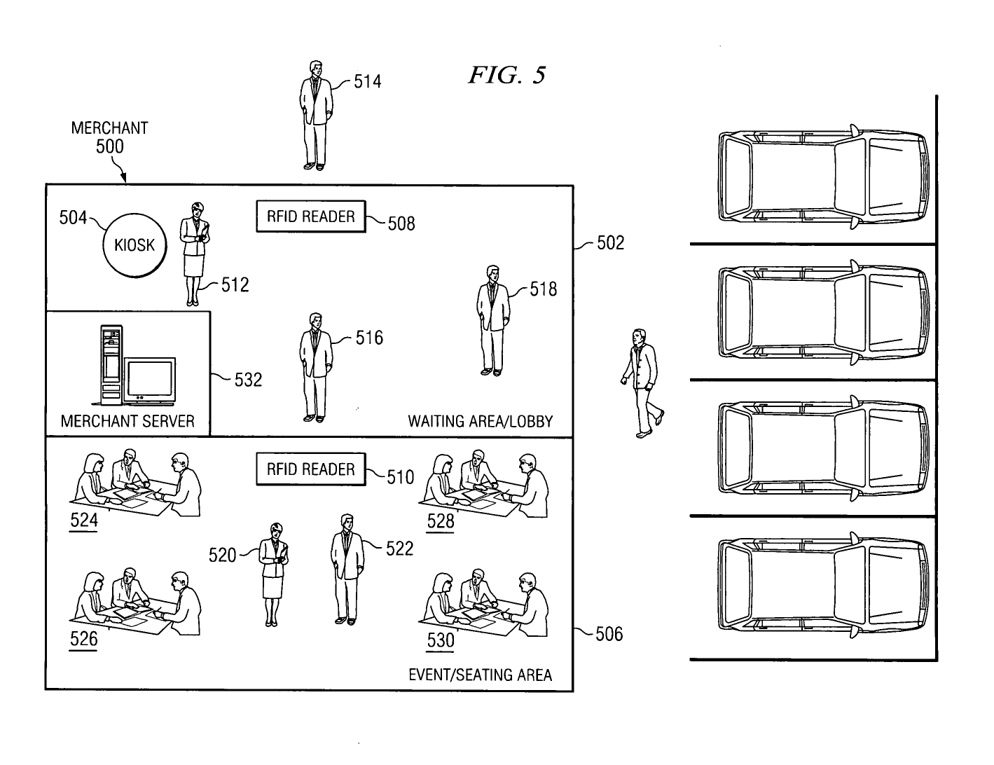

With reference to FIG. 5, a pictorial representation of a specific example of how patrons may be queued in accordance with a preferred embodiment of the present invention is depicted. It should be noted that in the depicted example, patrons 512-530 have an RFID embedded PCD. Merchant 500 has waiting area/lobby 502 and event/seating area 506. Waiting area/lobby 502 is for arriving and waiting patrons, such as patrons 512, 514, 516, and 518. Waiting area 502 may contain kiosk 504 for active patron registration, merchant server 532, such as, for example, merchant server 120 in FIG. 1, for patron management, and RFID reader/interrogator 508 for passive patron registration.

In one embodiment of the present invention, patron 512 may actively register at kiosk 504 to be placed in a queue by merchant server 532 by using her RFID embedded PCD, such as, for example, client PCD 140 in FIG. 1. It should also be noted that kiosk 504 may contain an RFID reader/interrogator to detect patron's unique RFID signature during active registration for the purpose of sending the unique signature to merchant server 532 to be placed in the queue. In addition, kiosk 504 may contain, for example, a personal or notebook computer for registration of patrons without a RFID embedded PCD.

In another embodiment of the present invention, patron 514 may passively register for the queue by passing RFID reader 508, at the entrance of waiting area 502, with his RFID enabled PCD. Patrons 512-518 wait in lobby 502 until merchant server 532 sends notification to the PCDs of patrons 512-518 that the event time has been reached or that seating is now available.

Event/seating area 506 is for patrons that have been notified by merchant server 532 to enter area 506, such as individual patrons 520 and 522 and group patrons 524, 526, 528, and 530. Event/seating area 506 may contain RFID reader/interrogator 510. In one embodiment of the present invention, RFID reader 510 may be utilized to passively acknowledge patron notification. For example, patron 516, after receiving notification by merchant server 532 that the event time have been reached or that seating is now available, may enter event/seating area 506 by passing RFID reader 510 with his RFID enabled PCD, thereby passively acknowledging notification. Subsequent to patron acknowledgement of notification, or failure to acknowledge notification after a predetermined maximum amount of times, merchant server 532 will remove the patron's unique RFID signature from the queue.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for automatically queuing a patron, the method comprising:
responsive to receiving a request for registration for a queue from the patron using a personal communication device, registering and placing the patron in the queue;
determining if an event has occurred;
notifying the patron that the event has occurred via the personal communication device; and
responsive to receiving an acknowledgement of the notification from the patron using the personal communication device, removing the patron from the queue.

2. The method of claim 1, wherein the personal communication device is embedded with a radio frequency identification device and wherein the radio frequency identification device is detected by a radio frequency identification reader and is used in the registering step.

3. The method of claim 1, wherein the personal communication device is at least one of a cellular telephone, a personal digital assistant, and a handheld computer.

4. The method of claim 1, wherein the registration and the acknowledgement is active.

5. The method of claim 1, wherein the registering, placing, determining, notifying, and removing steps are executed by a server.

6. The method of claim 5, wherein the notifying step is executed by the server a predetermined maximum number of times.

7. The method of claim 1, wherein the notifying step is at least one of an individual patron notification and a mass patron notification.

8. The method of claim 4, wherein passive registration and passive acknowledgment is performed by a radio frequency identification enabled personal communication device.

9. The method of claim 4, wherein active registration and active acknowledgement is performed using the personal communication device at an on-site kiosk.

10. The method of claim 1, wherein the event is at least one of a specified time and an available seat.

11. A data processing system comprising:
a bus system;
a memory connected to the bus system, wherein the memory includes a set of instructions; and
a processing unit connected to the bus system, wherein the processing unit executes the set of instructions to register and place a patron in a queue in response to receiving a request for registration for the queue from the patron using a personal communication device, determine if an event has occurred, notify the patron that the event has occurred via the personal communication device, and remove the patron from the queue in response to receiving an acknowledgement of the notification from the patron using the personal communication device.

12. The data processing system of claim 11, wherein the personal communication device is embedded with a radio frequency identification device and wherein the radio frequency identification device is detected by a radio frequency identification reader and is used in the registering step.

13. The data processing system of claim 11, wherein the personal communication device is at least one of a cellular telephone, a personal digital assistant, and a handheld computer.

14. The data processing system of claim 11, wherein the registering, placing, determining, notifying, and removing steps are executed by a server.

15. The data processing system of claim 11, wherein the notifying step is at least one of an individual patron notification and a mass patron notification.

16. A computer program product in a computer-readable medium for automatically queuing a patron, comprising:
first instructions for registering and placing the patron in a queue in response to receiving a request for registration for the queue from the patron using a personal communication device;
second instructions for determining if an event has occurred;
third instructions for notifying the patron that the event has occurred via the personal communication device; and
fourth instructions for removing the patron from the queue in response to receiving an acknowledgement of the notification from the patron using the personal communication device.

17. The computer program product as recited in claim 16, wherein the registration and the acknowledgement is active.

18. The computer program product as recited in claim 17, wherein passive registration and passive acknowledgment is performed by a radio frequency identification enabled personal communication device.

19. The computer program product as recited in claim 17, wherein active registration and active acknowledgement is performed using the personal communication device at an on-site kiosk.

20. The computer program product as recited in claim 16, wherein the event is at least one of a specified time and an available seat.
